(19) United States
(12) Patent Application Publication
(10) Pub. No.: US 2014/0280745 A1
(43) Pub. Date: Sep. 18, 2014

(54) Probabilistic Method For Scoring and Segmenting Online Personalities

(71) Applicant: VERSIUM ANALYTICS, INC., Redmond, WA (US)

(72) Inventors: Kevin Marcus, Woodinville, WA (US); Chris Matty, Medina, WA (US); Ryan McGavran, Arlington, VA (US); Kapenda Thomas, Bellevue, WA (US); Wesley Noel, Bothell, WA (US)

(73) Assignee: Versium Analytics, Inc., Redmond, WA (US)

(21) Appl. No.: 13/828,075

(22) Filed: Mar. 14, 2013

(51) Int. Cl. H04L 29/08

(52) U.S. Cl. CPC H04L 67/02
USPC 709/219

(57) ABSTRACT

The present invention relates to a system, method, or a computer program product that uses third-party data sources for the verification and profiling of identifier information including, for example, email address identifiers. The present invention uses identifier information to gather, aggregate, and record identifier-related data which is then sorted and scored based on user-determined criteria and source biased weighting. The score that is obtained can relate to identifier verification and/or profiling of the identifier for various purposes, and also may be used to detect the potential of fraud associated with the identifier.

### BACKGROUND OF THE INVENTION

Current email address validation systems validate email via one of two primary methods. The first method is to attempt to use Simple Mail Transfer Protocol (“SMTP”) to “ping” an email address via the VRFY or EXPN commands. Alternatively, an email is actually sent to the email address to check whether or not it bounces. Several companies have created large lists or ‘bounce files’ which indicate the history of email activity to a particular address. This first method uses archaic modes that are not well supported throughout the industry. The second method is to use a domain's website to check for the presence of an account. For example, if an email address is “joe@yahoo.com,” the service will check to see if there is a user, or operator, account at yahoo.com with this name. This method has many problems including the failure to indicate account activity and in some cases, even the presence of an account does not indicate its ability to receive email.

There is a need for an improved email address and other identifier validation system. The system of the present invention addresses shortcomings of current email address validation systems, differs from these systems in several respects, and also provides several additional advantages over these systems. Unlike current email address validation systems, the system of the present invention is not limited to the validation of email addresses and does not use SMTP protocol, but instead operates on HTTP/S. Also, unlike current email address validation systems, the present invention checks for active use of many different kinds of identifiers, including email addresses, on websites other than the identifier origin websites. For example, an email service provider website is not checked for the presence of an email address identifier originating from that website and a handle identifier originating from Twitter™ is not checked for its presence on Twitter™.

### BRIEF SUMMARY OF THE INVENTION

The present invention relates to a system, method, or a computer program product for the verification and profiling of identifier information including, for example, email address identifiers. The present invention uses certain pre-selected identifier information as a basis for gathering, aggregating, and recording identifier-related data which is then sorted and scored based on user-determined criteria and result source biased weighting. The score that is obtained can relate to identifier verification and/or profiling of the identifier for various purposes. Optionally, the score can be used to detect the potential of fraud associated with the identifier. While the verification and profiling of email address identifiers is specifically addressed, other types of widely used identifiers (phone numbers, access tokens, etc.) also might be used.

Importantly, the present invention develops information about an identifier principally or exclusively based on third party website data. As used within this invention disclosure, the term “website” includes any information or information service that can be accessed via an electronic network. This is because it is believed that third party website data provides fair and unbiased information relating to the validity and use of identifiers. The present invention can, in fact, identify and/or not check for and/or exclude data from a non-third party website (i.e., an origin website) relating to a particular identifier using its verification and profiling system, method, and computer program product. Accordingly, in a particularly preferred embodiment, for a given identifier, the present invention excludes identifier-related information from the website associated with the generation or origin of that identifier. For example, identifier-related information associated with an “@yahoo.com” email address identifier will not be used if it comes from the Yahoo email website. In another example, identifier-related information associated with a telephone number identifier such as “123-456-7890” will not be used if it comes from a Telco.

Further, the system of the present invention can be fully automated for real time operation, and is observation based, such that it does not require requesting specific operator information from operators themselves. Furthermore, the system of the present invention is easily distributable across many varied service providers, such that if the use of one website becomes problematic, others can be used in its place. The system of the present invention may also use proxy servers, virtual private networks (VPNs), or other widely available mechanisms to deal with problems that plague the SMTP protocol (such as rate limiting, blacklisting IPs, etc.).

### BRIEF DESCRIPTION OF THE DRAWINGS

FIG. 1 is a flow chart depicting a sequence of events according to the present invention including the selection of an email address for profiling, identification of categorized websites to be searched, optional searches to be performed at each website, recording of each website's response to the search(es), and generating a score based on the cumulative search results that reflect the probability of email usability and/or other profiling information.

FIG. 2 is a flow chart depicting a sequence of events according to the present invention starting from an identifier that is used to generate a list of websites to be searched and then searching each website by one or more of email address, telephone number, name, password recovery attempts, and account creation attempts. Any information found on the searched websites is recorded and all websites are searched. Once the searching has concluded, information relating to the websites where the identifier exists is returned to the user.

### DETAILED DESCRIPTION OF THE INVENTION

The present invention addresses and overcomes several problems associated with developing reliable identifier verification, profiling information, and fraud information. The present invention generates information based on the provision and subsequent analysis and scoring of information related to one or more single identifier data points. For example, the present invention can be beneficially used by those starting with relatively limited information such as a single identifier data point to determine identifier quality and utility, to develop profiling information, and/or to build a fraud-probability or confidence score based on that identifier.

The present invention enables several beneficial uses of information including, but not limited to, permitting: email marketers to build confidence in their mailing lists, avoid bounces, spam traps, and other deleterious email practices; better determination of whether a new website operator is legitimate; payment systems to include signal information to determine whether an operator is likely to be a shopper; use of long term activity for an identifier on an e-commerce website to indicate a reduced likelihood of fraudulent activity; and marketers and analytics agencies to use this information to further segment users. For example, with regard to segmentation, if a particular identifier appears to exist frequently on coupon websites, one can infer the operator is interested in coupons. Alternatively, if the identifier appears frequently on popular financial websites, one can infer that the operator has an interest in the finance segment.

Email address identifiers are specifically addressed below, but other types of widely used identifiers such as online ‘handles’, social network identifiers, phone numbers, addresses, access tokens, etc., also might be used, either separately or in any combination with other identifiers as part of this invention.

Verification means one is able to perform any of the following: (1) determine that an identifier is valid, correct, and active; (2) in the case where the identifier is an email, determine that the email address is an account capable of receiving email, and probably not a fake or fraudulent account; (3) when combined with other identifiers, such as a name, determine that the identifier is likely to be associated with the name—for example, determine that an email address and name in fact relate to the same operator by locating the user's social network page and confirming this information; and (4) assert that a particular segment (such as shopping or finance) is likely to be associated with an identifier.

Profiling means inferring segmentation (interest-level based on website-level categories) information and activity level (frequency, how recently active, active for how long) information from publicly facing observables. Here, publicly facing observables essentially means information that has been posted and that would be available via a search engine, blog, internet website, etc., and/or information that is either in the public domain or is otherwise available for free, such as public records, articles and information from Wikipedia™, etc. Notably, profiling, by use of the present invention can be advantageously done without requiring operator interaction.

The systems, methods, and computer-readable programs associated with this invention begin with certain pre-selected identifier data as a basis for gathering, aggregating, and recording identifier-related information which is then sorted and scored based on user-determined criteria and result source biased weighting in order to provide a score indicative of identifier validity, profiling, and/or fraud.

Identifiers

Various identifiers can be used in the present invention. Although email address identifiers are specifically addressed herein, other types of identifiers such as online ‘handles’, social network identifiers, phone numbers, addresses, access tokens, etc., might also be used.

The origin of the identifiers subject to analysis and scoring can alter the way that this information is processed by the present invention (e.g., if the identifier information is provided by third parties, purchased, automatically generated, generated using particular criteria, etc.). Further, identifier information can be pre-screened, sorted, categorized, or otherwise altered by man or machine before it is subject to further analysis according to the present invention.

Use of particular identifiers will vary based on the varied capabilities of different websites to be searched, or queried. For example, the “login and/or search features” of different websites vary. Many websites use an email address as the identifier to log in. However, in some cases an operator's real name or perhaps a handle will be provided by the website to hide the operator's email address. In such cases, the present invention will search for the presence of the operator from the handle or real name. Also, different websites have different facilities to locate members, and will typically disseminate different information. For example, social networking websites tend to show a lot of operator information, while shopping websites may show recent purchases or ‘wish lists.’ Depending on the type of verification desired and the facilities provided by websites to be searched, the present invention includes a wide range of sorting and categorization to take place before searching starts.

Gathering, Aggregating, and Storing Identifier-Related Information

In one unique aspect of the present invention, the active use of identifiers such as email addresses is checked on websites other than email service provider websites. For example, the user of the invention can identify desirable websites such as social networks and other large websites, or any particular website(s) of interest, as a starting point to check for the presence of and activity related to an email address.

The present invention corroboratively aggregates information from many different selected websites. The more websites that indicate the presence of and/or activity related to a particular email address, especially those websites indicating more recent valid activity, the more likely that that email address is valid and useful as a contact. Similarly, the greater the presence and activity of a particular email address across several websites, the less likely that email address is to be a spam trap.

In some instances, the user may select websites, or a category, or categories of websites, to check for the presence of an email address around a particular segment. The term segment, as used herein, refers to website categorization. Some website category segments might include, for example, websites categorized as one or more of social networking, finance, coupons, shopping, auctions, or news websites. Segmentation or categorization of websites and/or information returned by the present invention provides more targeted information gathering and provides several beneficial applications to users of the present invention.

For example, segmentation or categorization of websites searched and/or information gathered can be used by list owners or services that are interested in better understanding their customer base by obtaining information about other types of websites in the same category, or in different categories, that their customers use. Some list owners or services may be further interested to segment their own customer base based on the websites that a particular operator uses. For example, if a list owner or service has an email marketing campaign that involves online shopping, they may further want to identify potentially interested recipients by determining which email addresses also exist on websites categorized in a shopping websites segment. As another example, the list owner or service may select to check for the presence of a particular email address in a coupon-related segment by checking one or more online coupon websites to see whether or not a particular email address is likely to receive coupon offers by email.

After identifying selected websites, or a category, or categories of websites for searching, each website is checked for the presence of an email address and/or other identifiers. Checking for the presence of an email address or other identifiers can be performed by an automated service that, potentially with a proxy network, attempts to validate the presence and use of the email address on the identified selected websites. For example, in one embodiment, a proxy or virtual private network (“VPN”) can be used to overcome rate limiting features employed by many popular websites. That is, use of a proxy network or VPN can be optionally used as a scalability component, but is not a necessary requirement of the invention. For example, some websites may only allow some number of searches per hour. With a proxy network or VPN, it is possible to come from many different internet protocols (“IPs”) to defeat this rate limiting website feature.

The present invention can detect when a challenge-response system is put in place and leverage systems to defeat challenge-response systems. That is, the present invention can alter its approach to each website and can also handle rate-limiting features (for example, rate limiting that occurs by IP address) as well as CAPTCHAs (“Completely Automated Public Turing test to tell Computers and Humans Apart”). A proxy network or VPN can deal with these types of rate limits at scale. The system is also capable of using application programming interfaces (“APIs”) that may be available via the use of a developer key or by a customized web crawler which can submit forms.

The present invention is also very good at ferreting out email address “spam traps.” Spam traps are email addresses which are either invalid for a long period of time, or that are specifically set up to receive spam by various anti-spam websites. When email is received to these email addresses, they immediately notify postmasters and shut down the mailer. Because the present invention is corroboratively aggregating information from many different websites, the more websites that have a particular account, especially with more recent valid activity, the less likely the email address is to be a spam trap.

In one embodiment, selected websites are checked for the presence or use of an email address identifier by one or more of using the website's offer to search for email address information, attempting to create an account at a website by using an email address identifier to see if doing so prompts an error message, using the email address identifier in relation to a website's password recovery to see if doing so prompts an informative message from the website, or using APIs to search websites for information related to an email address identifier. For example, and as indicated in FIG. 2, the present invention can use the facilities offered by the website to check for an email address by doing one or more of the following: (1) searching for an account; (2) creating an account; or (3) recovering a password. Searching for an account, option (1) above, may be as simple as looking for an identifier within the website, using web search engines to find an identifier at the website, using matching technology to match an identifier to a website, or using APIs that the website offers to developers to use for exactly these purposes.

As depicted in FIG. 1, one embodiment of the present invention involves receiving an identifier, generating a list of websites capable of using the identifier and, then, for each website identified, sequentially searching identifiers (email address, telephone number, name, attempting password recovery, and/or trying to create an account), until information related to the identifier is found. Once information related to the identifier is found, the presence of this information on a website is recorded. Once all the websites are searched, information regarding websites having pertinent information is returned and this information may be further segmented or categorized.

Identifiers selection is partly based on what the search is for and how various websites support searches/queries. Common examples of identifiers include email addresses, phone numbers, handles, etc. In the event that a particular identifier, such as an email address is used for a search, but the websites of interest do not support searches by email address, then there would be no information returned for this specific identifier. Generally, however, any website that supports one or more particular identifiers of interest, i.e., has information related to that identifier, would be usable in connection with this invention.

The searches performed using this invention may be wholly automated. Search requests, or queries, are submitted to third party websites to check for publicly facing observables that can be used to locate identifier information.

Websites to be searched can be selected by determining which websites support searches for certain types of identifiers (pairing of searches with available information) and/or by segment. For example, Amazon supports email presence search and is a commerce website. So, if a user of the present invention wanted to profile an email address to see if it was active on e-commerce websites, the Amazon website would be searched. Ebay is another commerce website that supports email address presence search (via account creation/password recovery) and, thus, may also be included. Broadly speaking, the selection of websites to be searched can be an automatic process based on the identifiers selected for search, the identifiers supported by various websites and, optionally, any segmentation that may be applied.

The selection of websites to be searched may be wholly automated, and may result from a database query which contains a list of the websites, the identifiers they support, and optionally, segmentation of the website into one or more segments.

Additionally, each website to be searched will have different contact mechanisms. In a preferred embodiment of the invention, a database of websites for searching also contains “website handler” information indicating how a particular website is contacted. “Website handler” information can take on many forms such as the use of an API provided by the website, using the search interface provided by the website, using a web-crawled interface of the website and matching the results to the user identifiers, using the login portion of the website, using the password recovery portion of the website, using the registration portion of the website, viewing profiles of other users, and/or any other facilities the website provides to be able to perform an identifier presence test. In a particularly preferred embodiment, these website contact processes are always automated and always electronic.

Responses secured from website contacts are received electronically, parsed, and/or matched to determine whether or not there is presence of the identifier on the website. Information specific to the presence of the identifier can, optionally, include any other information associated with the identifier that is provided by the contact website is recorded. Recordation of information obtained for an identifier search of a website contact varies from website to website based, in part, on the information that is available. For example, some websites may provide an API to look up users by various identifiers in which case the present invention would then record whether a particular identifier is or is not available on that particular website. This information is recorded as the response for whether or not the identifier is present on the specific website that was searched. This response is then passed back to the machine component that issued the request.

A cache of responses relating to the matching of identifier information on websites searched is maintained. In a preferred embodiment, the storing of the data collected by the present invention is very straightforward and notes information including, but not necessarily limited to: identifier, timestamp, website checked, presence indicator, most recent activity, and any information relating to name/value pairs containing information specific to the individual website responses (which may vary widely).

Attempts to validate the presence and use of the email address on the identified selected websites, and the results of these attempts, are recorded and stored for use in subsequent analysis.

Sorting and Scoring Identifier-Related Data Based on User-Specific Criteria

The recorded results from all of the scans and attempts relating to the presence of email addresses and/or other identifiers are subject to sorting and scoring. Broadly speaking, the more occurrences of an email address and/or other identifiers that are located, the more likely the email address is to be scored indicating that it is in use and/or active. Furthermore, some websites will reveal some information about the email address and/or other identifiers such as a name, location, etc. This additional information is also gathered and can be used to further score, segment, validate, or confirm the existence of an email address. Such additional information can be relationally (like a database) associated with the email address and can include the identifier, timestamp, verification method, and response.

The post-processing of these recorded results is used for profiling and validating identifiers. The present invention parses the data returned and flags identifiers as good or bad as such relates to the user's purposes.

One embodiment of the present invention uses hypertext preprocessor's (“PHP's”) preg_match function to handle responses prompted by the present invention, but any text parsing function will be able to handle the responses. The returned data is flagged by determining whether or not the response indicated that 1) the account is valid and provides information associated with the account, 2) the account does not exist, and 3) the account exists but no additional information is available. Identifiers can be considered good or bad, a determination that can be adjusted depending on how the information associated with the identifiers relates to the purposes of the user of the present invention. Generally, determination of whether an identifier is good or bad is based on its presence as an active account in a particular segment or its existence on a particular website. For example, if a user wanted to validate whether an email address was valid and the user finds an operator with that email address actively posting new content on a social network, the email address would be determined to be good, or bad if no such presence was indicated.

Information gathered based on a particular identifier may include profiling information gleaned during the validation process, which also recovers and records related or ancillary data.

In a preferred embodiment, the system operates primarily on social networks and is used for checking account activity levels, by using, for example, one or more of email address, handle, and phone identifiers. Results are sorted based on the confidence of the match. Match confidence, in turn, is based on the quality of the data match and the total data returned by the search. For example, a search may be conducted on a record that has each of name, address, phone, and email address identifiers. In this scenario, the present invention first validates that the email address is in use on Twitter™. Then the present invention may also find that there is an operator on Twitter™ with the same name and location as the operator about which data is being gathered. This additional information may be used to determine a score of a medium level of confidence. If, however, the name of the operator about which data is being gathered is especially unusual, this additional information may be used to determine a score of a higher than medium level of confidence. Alternatively, or in addition to the above, information about an identification of a handle for the Twitter™ operator which also matches the ‘username’ portion of the email address about which data is being gathered may be used to determine a score of a higher than medium level of confidence. Accordingly, the present invention advantageously provides several alternatives to developing a reasoned score based on publicly facing observables pertaining to confidence levels associated with a particular identifier.

Once a high enough confidence is obtained for the identifier at hand, the present invention returns a match and, optionally, results to a user. In this case, if the same operator was actively tweeting, the present invention would permit the inference that the email address is probably a good email address that is not a spam trap, probably will not bounce, and probably belongs to the user.

Alternative embodiments of the present invention may incorporate the use of offline data such as names, addresses, telephone information, etc. Additionally, identifiers may be monitored for changes in activity. For example, an email address may be monitored for new membership on a dating website.

For example, validation of the presence of the email address on selected websites may be performed, in part, by the methods depicted in FIG. 1, steps 1-4. First, in step 1, an email address is selected for verification and/or profiling. In step 2, the selected email address is matched to a list of categorized websites for scanning Steps 3a-c provide that for each website identified for scanning in step 2, one or more of various options can be exercised to generate information relating to the validity and/or profiling of an email address. For example, step 3a provides the option of attempting to search for the email address with a search facility on the website. Step 3b provides the option of attempting to recover a password for the email address. Step 3c provides the option of attempting to create a new account using the email address. The information generated by exercising any one or more of options 3a-c is recorded and stored for further use. Step 4 is to calculate a score based on the cumulative results of step 3. The score generated in step 4 can be used to indicate probability that the email address is valid. The score generated in step 4 also can be used to infer things about the email address holder by profiling the email address based on its presence on specific categories of websites.

Various components of steps 3a-c may result in error responses that can be indicative of email address quality. For example, some websites may indicate that an email address and/or account is not valid, while others may say that it has been shut down. This information is used to further improve the scoring and quality of the system. For example, if an operator has an account closed at a payment platform website, this could be a negative indicator for quality and/or abuse, even though an email address may be genuine and emailable.

The scoring system looks to see how many websites contain the presence of the identifier. As a general matter, the more websites having a particular identifier, the higher the score that is assigned to that identifier. Further, for websites that indicate activity, evidence of more recent activity (for example, recent posts by the user) can also increase the score. Some websites also can be accorded a predetermined stronger weight that may also impacts their overall score. The predetermined weighting of particular websites may be proprietary and/or, adjusted depending on the needs of the client or user.

Additionally, in another embodiment, some websites may be accorded a negative score such that the presence of an identifier on these websites would have a negative impact on the score. By way of example only, such “negative” websites may be unscrupulous websites or otherwise deemed to be poor quality.

Prototype

The present invention requires access to the internet and something, such as a web browser, or software such as curl or wget to make web based requests, to process the information that comes back, and store the result. While the present invention may be built on almost any modern platform, a prototype of the present invention was made with a traditional stack using FreeBSD™ (or LINUX™), PHP and MySQL™. The present invention can generally operate from Amazon's AWS service. An API into Amazon's AWS service allows for either batch mode operation to validate a large number of email addresses or real time operation for one-by-one operation.

The present invention employs many countermeasures that are typically used to detect and/or thwart website automation, including CAPTCHAs, proxies, cookies, and other standard mechanisms. To avoid abuse of the services being searched and constant error generation, individual agents, i.e., the code which is running the searches, will log and terminate based on varied numbers of consecutive failures and implement an exponential back off algorithm.

Whenever possible, the present invention generally tries to avoid touching advertising systems. For example, some websites offer internet advertising where the advertising company is paid for impressions or show different ads based on the click-through rate. Any sort of automated system which touches those systems can skew their numbers and cause problems for the advertising systems. The present invention therefore tries to avoid any interaction with advertising systems whenever possible.

When the present invention was tested against similar commercial providers, it returned less than about 1% false positives, as compared to about 20% false positives generated by other commercial providers.

A particularly preferred embodiment of an automated computerized system for verifying or profiling identifier information associated with an individual operator of the present invention comprises an identifier associated with an individual operator; a computer program for executing search and retrieval instructions relating to the presence of the identifier on multiple third-party websites and for executing scoring instructions for at least one search result; a server for retrieving and transmitting search data; and a computing device for storing search result data. The identifier may be, for example, one of an email address, online handle, social network identifier, phone number, access token, address, etc. The system may further comprise at least one of a proxy server and a virtual private network and may operate in real time. The computer program for executing search and retrieval instructions may include instructions for selecting a list of third-party websites to be searched and searching for the presence of the identifier on each third-party website on the list. The computer program for executing search and retrieval instructions may also include instructions for exercising one or more search options, including: attempting to search for the identifier using a third-party website search facility; attempting to recover the identifier using a third-party website password recovery facility; and attempting to create a new account using the identifier and using a third-party website facility. The computer program for executing search and retrieval instructions may also include, for example, instructions for retrieving any additional information related to the presence of the identifier on the third-party website. The computer program for executing search and retrieval instructions may select a list of third-party websites to be searched based on segmentation, and the segmentation may be based on operator interests or user-specific critieria. The computer program for executing scoring instructions may account for the presence or absence of the identifier on each third-party website on the list of third-party websites. The computer program for executing scoring instructions may account for search results accumulated and corroborated from each third-party website on the list of third-party websites. The computer program for executing scoring instructions may assign different weights to the search results from each third-party website on the list of third-party websites. The computer program for executing scoring instructions may provide a score in the form of at least one of a verification, a confidence level, and a fraud score.

A particularly preferred embodiment of a method of data verification or profiling according to the present invention comprises selecting an identifier to be verified or profiled, wherein the identifier is associated with an individual operator; selecting, by the processor, a list of third-party websites to be searched and one or more data verification or profiling methods to be applied to each third-party website on the list selected from search options comprising: searching for the identifier using a third-party website search facility; recovering the identifier using a third-party website password recovery facility; and creating a new account using the identifier and using a third-party website facility; transmitting the data; storing the data; and scoring the data. This method may involve an identifier that is an email address, online handle, social network identifier, phone number, access token, or address, etc. This method may include storing data accounting for the presence or absence of the identifier on each third-party website, which data can also include any other information associated with the presence of the identifier on each third-party website. This method may include the segmentation of websites to be searched. The data gathered by this method may be corroborated, weighted, stored, and scored. According to this method, an identifier may be assigned a score that indicates at least one of a verification, a confidence level, and a fraud potential associated with the identifier. The method may also comprise using a proxy server and/or a virtual private network and may operate operating in real time.

A tangible computer-readable storage medium according to the present invention, may be used to accomplish the systems and methods described herein. The tangible computer-readable storage medium may comprise executable instructions for causing a user to verify or profile identifier information associated with an individual operator based on information from one or more third-parties. The tangible computer-readable storage medium may further comprise executable instructions for causing a user to conduct a search using segmentation.

1. An automated computerized system for verifying or profiling identifier information associated with an individual operator comprising:
an identifier associated with the individual operator;
a computer program for executing search and retrieval instructions relating to the presence of the identifier on at least one third-party website and for executing scoring instructions for at least one search result;
a server for retrieving and transmitting search data; and
a computing device for storing search result data.

2. The system of claim 1, wherein the identifier is one of an email address, online handle, social network identifier, phone number, access token, and address.

3. The system of claim 1, wherein the computer program for executing search and retrieval instructions includes instructions for selecting a list of third-party websites to be searched and searching for the presence of the identifier on each third-party website on the list and also, for each third-party website, instructions for exercising one or more search options, including:
attempting to search for the identifier using a third-party website search facility;
attempting to recover the identifier using a third-party website password recovery facility; and
attempting to create a new account using the identifier and using a third-party website facility.

4. The system of claim 3, wherein the computer program for executing scoring instructions accounts for the presence or absence of the identifier on each third-party website on the list of third-party websites.

5. The system of claim 4, wherein the computer program for executing scoring instructions accounts for search results accumulated and corroborated from each third-party website on the list of third-party websites.

6. The system of claim 5, wherein the score is provided in the form of at least one of a verification, a confidence level, and a fraud score.

7. The system of claim 3, wherein the selection of the list of third-party websites to be searched is based on segmentation.

8. The system of claim 7, wherein the segmentation is based on operator interests.

9. The system of claim 1, further comprising at least one of a proxy server and a virtual private network.

10. The system of claim 1, wherein the system operates in real time.

11. An automated method of data verification or profiling, comprising:
selecting, by a processor of a computing device, an identifier to be verified or profiled, wherein the identifier is associated with an individual operator;
selecting, by the processor of a computing device, a list of third-party websites to be searched and one or more data verification or profiling methods to be applied to each third-party website on the list selected from search options comprising:
searching for the identifier using a third-party website search facility;
recovering the identifier using a third-party website password recovery facility; and
creating a new account using the identifier and using a third-party website facility;
storing the data; and
scoring the data.

12. The automated method of claim 11, wherein the identifier is one of an email address, online handle, social network identifier, phone number, access token, and address.

13. The automated method of claim 11, wherein the data stored includes data accounting for the presence or absence of the identifier on each third-party website inclusive of any information associated the identifier.

14. The automated method of claim 11, wherein the list of third-party website facility websites to be searched is selected based on segmentation.

15. The automated method of claim 11, further comprising corroborating the stored data and weighting the data.

16. The automated method of claim 11, further comprising providing a score that indicates at least one of a verification, a confidence level, and a fraud potential associated with the identifier.

17. The automated method of claim 11, further comprising using at least one of a proxy server and a virtual private network.

18. The automated method of claim 11, further comprising operating in real time.

19. A tangible computer-readable storage medium comprising executable instructions for causing a user to verify or profile identifier information associated with an individual operator based on information from one or more third-parties.

20. The tangible computer-readable storage medium of claim 19, further comprising executable instructions for causing a user to conduct a search using segmentation.
